(19) United States
(12) Patent Application Publication
(10) Pub. No.: US 2023/0116501 A1
(43) Pub. Date: Apr. 13, 2023

(54) CUTTING APPARATUS AND CONTROL METHOD OF CUTTING APPARATUS

(71) Applicant: Horizon Inc., Takashima-shi (JP)

(72) Inventors: Satoshi TSUNAWAKI, Shiga (JP); Kazuyuki FUKUSHIMA, Shiga (JP); Katsufumi NAKANISHI, Shiga (JP); Osamu NISHIMURA, Shiga (JP); Tatsuaki IDA, Shiga (JP)

(21) Appl. No.: 17/960,555

(22) Filed: Oct. 5, 2022

(30) Foreign Application Priority Data
Oct. 13, 2021 (JP) 2021-168140

(51) Int. Cl. B26D 5/02

(52) U.S. Cl. CPC B26D 5/02

(57) ABSTRACT

Provided is a cutting apparatus including: a rotary table; a pressing unit; a cutting unit; a drive unit that rotates and moves the rotary table; a transport unit that transports a cut book in a transport direction to a stacking position; and a control unit that controls the drive unit and the transport unit, and the control unit performs, in a switchable manner, a first transport mode to transport a book having edges cut by the cutting unit in the transport direction in a state where the spine was rotated to be arranged in a predetermined direction about a rotation center of the rotary table and a second transport mode to transport a book having edges cut by the cutting unit in the transport direction in a state where the spine was rotated to be arranged in a direction different from the predetermined direction about the rotation center.

### CROSS-REFERENCE TO RELATED APPLICATION

This application claims foreign priority benefits under U.S.C. § 119 to Japanese Patent Application No. 2021-168140 filed on Oct. 13, 2021, the content of which is hereby incorporated by reference in its entirety.

### BACKGROUND

### 1. Technical Field

The present disclosure relates to a cutting apparatus and a control method of a cutting apparatus.

### 2. Description of Related Art

Conventionally, a cutting apparatus configured to cut edges of books by a cutting knife is known (for example, see Japanese Patent Application Laid-Open No. 2005-95994).

The cutting apparatus disclosed in Japanese Patent Application Laid-Open No. 2005-95994 has a rotary table, a pressing plate, and a cutting knife and is configured to place a book on the rotary table and fix the book by the pressing plate, rotate the rotary table by 90 degrees each time, and cut three sides of the top edge, the bottom edge, and the fore edge of the book by the cutting knife, respectively. The cutting apparatus transports the cut book along a transport path and stacks the transported cut book on a stack part.

In a book having a bound spine, the thickness on the spine side is larger than the thickness on the fore edge side. Thus, when a plurality of books having the same shape are stacked on the stack part, the height on the spine side of the plurality of stacked books is larger than the height on the fore edge side. This may prevent stable stacking of such a plurality of books, some of the books stacked on the upper side may be misaligned from books stacked on the lower side, and a book block of the plurality of books may collapse. If such misalignment or collapse of a book block occurs, an operator is unable to suitably pack the book block with a plurality of books being aligned therein.

To address the above problem, in stacking a plurality of books, one conceivable method is to change the orientation of some of the books so that the positions of spines of all the books are not the same and stack the books so that spines and fore edges face the same direction alternately for every predetermined number of books. To change the orientation of books, however, the operator is required to work to change the orientation of the books, or an additional device to change the orientation of books transported from the cutting apparatus is required.

### SUMMARY

The present disclosure has been made in view of such circumstances and intends to provide a cutting apparatus and a control method of a cutting apparatus that can suitably stack a plurality of books each having a bound spine while preventing the books from collapsing without requiring the operator to work to change the orientation of some of the books or an additional device to be provided for changing the orientation of some of the books.

A cutting apparatus according to one aspect of the present disclosure includes: a rotary table on which a book having a bound spine is to be placed; a pressing unit configured to press the book against the rotary table; a cutting unit configured to move a cutting knife between a cutting position and a non-cutting position and cut edges of the book except for the spine; a drive unit configured to rotate the rotary table with the book being pressed by the pressing unit and move the rotary table to the cutting unit; a transport unit configured to transport the book having the edges cut by the cutting unit in a transport direction to a stacking position; and a control unit configured to control the drive unit and the transport unit, and the control unit is configured to perform a first transport mode and a second transport mode in a switchable manner, the first transport mode is to transport the book having the edges cut by the cutting unit in the transport direction in a state where the spine was rotated to be arranged in a predetermined direction about a rotation center of the rotary table, and the second transport mode is to transport the book having the edges cut by the cutting unit in the transport direction in a state where the spine was rotated to be arranged in a direction different from the predetermined direction about the rotation center.

According to the cutting apparatus of one aspect of the present disclosure, a book having a bound spine is pressed against the rotary table by the pressing unit, the rotary table is rotated and positioned to the cutting unit by the drive unit. The book having edges cut by the cutting unit is transported in the transport direction to the stacking position by the transport unit. The drive unit and the transport unit are controlled by the control unit so as to perform the first transport mode and the second transport mode in a switchable manner.

The first transport mode and the second transport mode are switched therebetween and performed, and thereby the spine of the book transported to the stacking position in the first transport mode and the spine of the book transported to the stacking position in the second transport mode are arranged in different directions about the rotation center of the rotary table. Therefore, compared to a case where all the spines of a plurality of books stacked on the stacking position are arranged in the same direction about the rotation center of the rotary table, it is possible to prevent some of the books stacked on the upper side from being misaligned from books stacked on the lower side or prevent a plurality of books from collapsing due to a situation where the height of one area of the books is excessively higher than the height of another area of the books.

As described above, according to the cutting apparatus of one aspect of the present disclosure, it is possible to suitably stack a plurality of books each having a bound spine while preventing the books from collapsing without requiring the operator to work to change the orientation of some of the books or an additional device to be provided for changing the orientation of some of the books.

In the cutting apparatus according to one aspect of the present disclosure, the second transport mode may be a mode to transport the book having the edges cut by the cutting unit in the transport direction in a state where the spine was rotated to be arranged in an opposite direction to the predetermined direction about the rotation center.

According to the cutting apparatus of the present configuration, the first transport mode and the second transport mode are switched therebetween and performed, and thereby the spine of the book transported to the stacking position in the first transport mode and the spine of the book transported to the stacking position in the second transport mode are arranged in the opposite directions about the rotation center of the rotary table. Therefore, compared to a case where all the spines of the plurality of books stacked on the stacking position are arranged in the same direction about the rotation center of the rotary table, it is possible to more reliably prevent some of the books stacked on the upper side from being misaligned or prevent a plurality of books from collapsing.

The cutting apparatus of the configuration described above may be formed such that the control unit controls the drive unit so that a direction in which the spine extends matches the transport direction in both the first transport mode and the second transport mode.

According to the cutting apparatus of the present form, by controlling the drive unit so that the direction in which the spine extends matches the transport direction, it is possible to stack a plurality of books on the stacking position with the direction in which the spine extends being matched to the transport direction.

In the cutting apparatus of the form described above, the control unit may control the drive unit so that, in a width direction orthogonal to the transport direction, the position of the spine of the book transported in the first transport mode matches the position of a fore edge of the book transported in the second transport mode.

According to the cutting apparatus described above, since the position of the spine of the book transported in the first transport mode matches the position of a fore edge of the book transported in the second transport mode, a plurality of books stacked on the stacking position are suitably stacked on the same position in the width direction.

In the cutting apparatus according to one aspect of the present disclosure, the control unit may be configured to switch the first transport mode to the second transport mode in response to completion of transport of a predetermined number of books in the first transport mode and switch the second transport mode to the first transport mode in response to completion of transport of the predetermined number of books in the second transport mode.

According to the cutting apparatus of the present configuration, since the first transport mode and the second transport mode are switched therebetween in response to completion of transport of a predetermined number of books, the position of the spine and the position of the fore edge of the books stacked on the stacking position are switched therebetween for every predetermined number of books, and misalignment or collapse of a plurality of books can be suitably prevented.

In the cutting apparatus according to one aspect of the present disclosure, the control unit may be configured to switch the first transport mode to the second transport mode so that a total thickness of books continuously transported in the first transport mode does not exceed a predetermined value and switch the second transport mode to the first transport mode so that a total thickness of books continuously transported in the second transport mode does not exceed the predetermined value.

According to the cutting apparatus of the present configuration, the transport mode is switched so that the total thickness of books continuously transported in either the first transport mode or the second transport mode does not exceed a predetermined value. Thus, the position of the spine and the position of the fore edge of the books stacked on the stacking position are switched therebetween in accordance with the height (the total thickness) of a plurality of stacked books, and misalignment or collapse of a plurality of books can be suitably prevented.

In a control method of a cutting apparatus according to one aspect of the present disclosure, the cutting apparatus includes a rotary table on which a book having a bound spine is to be placed, a pressing unit configured to press the book against the rotary table, a cutting unit configured to move a cutting knife between a cutting position and a non-cutting position and cut edges of the book except for the spine, a drive unit configured to rotate the rotary table with the book being pressed by the pressing unit and move the rotary table to the cutting unit, and a transport unit configured to transport the book having the edges cut by the cutting unit in a transport direction to a stacking position, and the control method includes: a first control step of performing a first transport mode to control the drive unit and the transport unit to transport the book having the edges cut by the cutting unit in the transport direction in a state where the spine was rotated to be arranged in a predetermined direction about a rotation center of the rotary table; and a second control step of performing a second transport mode to control the drive unit and the transport unit to transport the book having the edges cut by the cutting unit in the transport direction in a state where the spine was rotated to be arranged in a direction different from the predetermined direction about the rotation center.

According to the control method of the cutting apparatus of one aspect of the present disclosure, a book having a bound spine is pressed against the rotary table by the pressing unit, and the rotary table is rotated and positioned to the cutting unit by the drive unit. The book having edges cut by the cutting unit is transported in the transport direction to the stacking position by the transport unit. The drive unit and the transport unit are controlled by the first control step and the second control step so as to perform the first transport mode and the second transport mode in a switchable manner.

The first transport mode and the second transport mode are switched therebetween and performed, and thereby the spine of the book transported to the stacking position in the first transport mode and the spine of the book transported to the stacking position in the second transport mode are arranged in different directions about the rotation center of the rotary table. Therefore, compared to a case where all the spines of a plurality of books stacked on the stacking position are arranged in the same direction about the rotation center of the rotary table, it is possible to prevent some of the books stacked on the upper side from being misaligned from books stacked on the lower side or prevent a plurality of books from collapsing due to a situation where the height of one area of the books is excessively higher than the height of another area of the books.

As described above, according to the control method of the cutting apparatus of one aspect of the present disclosure, it is possible to suitably stack a plurality of books each having a bound spine while preventing the books from collapsing without requiring the operator to work to change the orientation of some of the books or an additional device to be provided for changing the orientation of some of the books.

According to the present disclosure, it is possible to provide a cutting apparatus and a control method of a cutting apparatus that can suitably stack a plurality of books each having a bound spine while preventing the books from collapsing without requiring the operator to work to change the orientation of some of the books or an additional device to be provided for changing the orientation of some of the books.

### BRIEF DESCRIPTION OF THE DRAWINGS

FIG. 1 is a perspective view illustrating an overall configuration of a three-side cutting apparatus according to one embodiment of the present disclosure.

FIG. 2 is a perspective view illustrating a book cut by the three-side cutting apparatus illustrated in FIG. 1.

FIG. 3 is a diagram of a book block of a plurality of stacked books when viewed from the bottom edge side and illustrates a state where the positions of spines of all the books are matched.

FIG. 4 is a diagram of a book block of a plurality of stacked books when viewed from the bottom edge side and illustrates a state where the position of spines of books on the upper side and the position of spines of books on the lower side are opposite to each other about the rotation center of a rotary table.

FIG. 5 is a partial enlarged view of a part near the rotary table of the three-side cutting apparatus illustrated in FIG. 1.

FIG. 6 is a front view illustrating a transport unit, an accumulation unit, and a discharge unit and illustrates a state where no book is stacked on a shelf.

FIG. 7 is a front view illustrating the transport unit, the accumulation unit, and the discharge unit and illustrates a state where a book is stacked on the shelf.

FIG. 8 is a front view illustrating the transport unit, the accumulation unit, and the discharge unit and illustrates a state where a proximity sensor detects a plate to be detected.

FIG. 9 is a block diagram illustrating a general configuration of the three-side cutting apparatus.

FIG. 10 is a flowchart illustrating a control method of the three-side cutting apparatus performed by a control unit.

FIG. 11 is a flowchart illustrating each process in a first transport mode performed in FIG. 10.

FIG. 12 is a flowchart illustrating each process in a second transport mode performed in FIG. 10.

FIG. 13 is a diagram illustrating a setting window for setting a stacking mode.

FIG. 14 is a plan view illustrating a general configuration of a cutting unit, the transport unit, the accumulation unit, and a supply unit.

FIG. 15 is a plan view illustrating a general configuration of the cutting unit, the transport unit, the accumulation unit, and the supply unit.

FIG. 16 is a plan view illustrating a general configuration of the cutting unit, the transport unit, the accumulation unit, and the supply unit.

FIG. 17 is a plan view illustrating a general configuration of the cutting unit, the transport unit, the accumulation unit, and the supply unit.

FIG. 18 is a plan view illustrating a general configuration of the cutting unit, the transport unit, the accumulation unit, and the supply unit.

FIG. 19 is a plan view illustrating a general configuration of the cutting unit, the transport unit, the accumulation unit, and the supply unit.

FIG. 20 is a plan view illustrating a general configuration of the cutting unit, the transport unit, the accumulation unit, and the supply unit.

### DETAILED DESCRIPTION

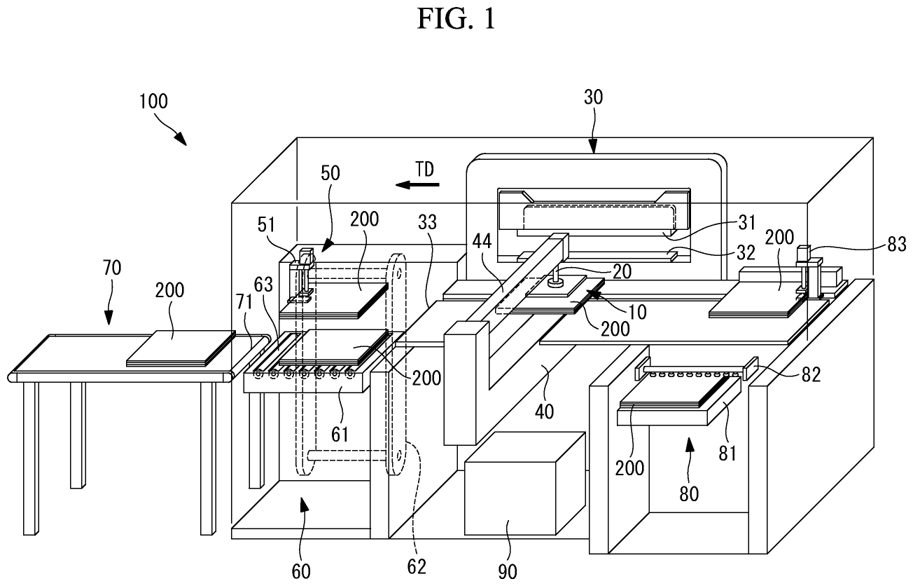

A three-side cutting apparatus 100 according to one embodiment of the present disclosure will be described below with reference to the drawings. FIG. 1 is a perspective view illustrating the overall configuration of the three-side cutting apparatus 100 according to the present embodiment. As illustrated in FIG. 1, the three-side cutting apparatus 100 includes a rotary table 10, a pressing unit 20, a cutting unit 30, a drive unit 40, a transport unit 50, an accumulation unit 60, a discharge unit 70, a supply unit 80, and a control unit 90.

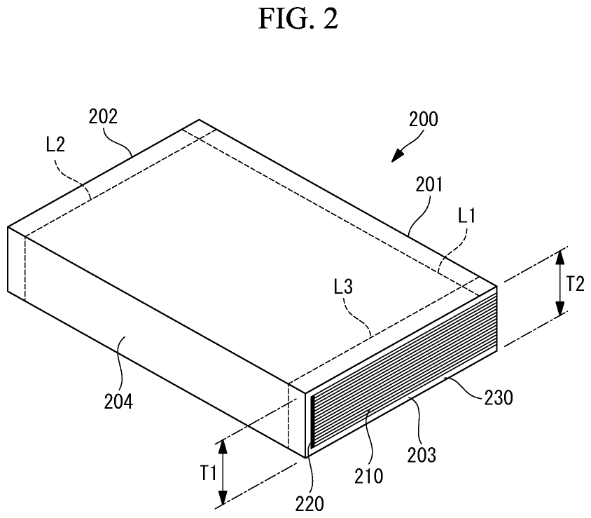

The three-side cutting apparatus 100 of the present embodiment is an apparatus configured to cut three edges of a book 200 having a bound spine 204. FIG. 2 is a perspective view illustrating the book 200 cut by the three-side cutting apparatus 100 illustrated in FIG. 1. As illustrated in FIG. 2, the book 200 has the spine 204 bound such that a plurality of layered sheets 210 are glued together by a glue 220 and cased with a cover 230.

Although the book 200 illustrated in FIG. 2 is formed such that a plurality of sheets 210 are glued by the glue 220 and cased with the cover 230, another form may be employed. For example, the book 200 may be a tape-bound book with a cloth tape attached to the spine 204. Further, for example, the book 200 may be a pad-bound book whose spine 204 is glued but is not cased by a cover. Further, the book 200 may be a book whose spine 204 is sewn by using a thread, a needle, or the like.

The book 200 is supplied from the supply unit 80 to the cutting unit 30 and cut along a cut line L1 on the fore edge 201 side, a cut line L2 on the top edge 202 side, and a cut line L3 on the bottom edge 203 side by the cutting unit 30. In the book 200, the sheets 210 on the spine 204 side are glued together by the glue 220, and the spine 204 is cased by the cover 230. Thus, the thickness T1 of the spine 204 of the book 200 is greater than the thickness T2 of the fore edge 201 of the book 200.

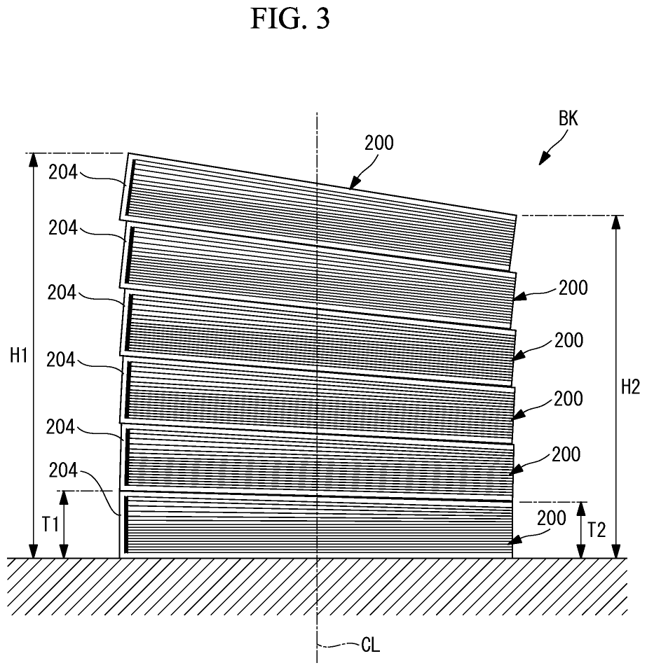

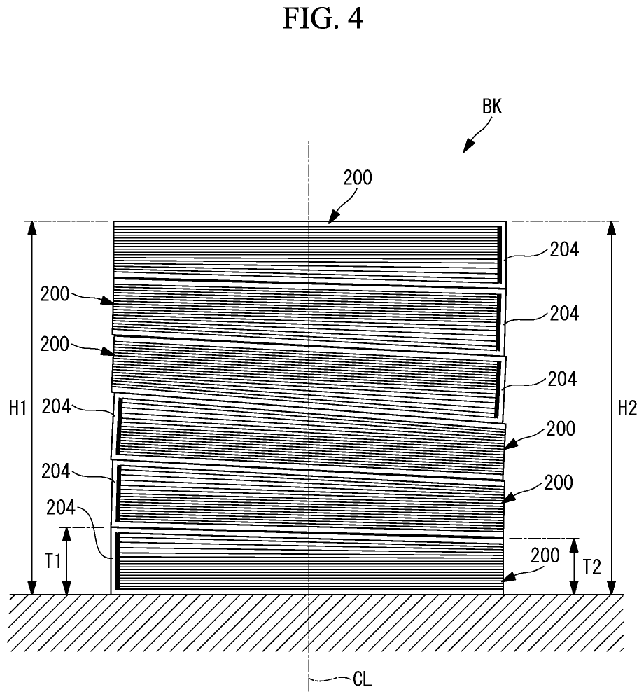

FIG. 3 is a diagram of a book block BK in which a plurality of books 200 are stacked when viewed from the bottom edge side and illustrates a state where the positions of spines 204 of all the books 200 are matched. FIG. 4 is a diagram of the book block BK in which the plurality of books 200 are stacked when viewed from the bottom edge side and illustrates a state where the position of the spines 204 of the books 200 on the upper side and the position of the spines 204 of the books 200 on the lower side are opposite to each other about the center CL of the books 200.

As illustrated in FIG. 3, the thickness T1 of the spine 204 of the book 200 is greater than the thickness T2 of the fore edge 201 of the book 200. Thus, with the positions of the spines 204 of all the books 200 being matched, the height H1 on one side (the left side in FIG. 3) of the book block BK is higher than the height H2 on the other side (the right side in FIG. 3) of the book block BK.

In such a state, as the number of stacked books 200 increases, the difference between the height H1 on the one side and the height H2 on the other side of the book block BK increases. This causes the books 200 on the upper side to be misaligned from the books 200 on the lower side or may cause the whole book block BK to collapse.

In contrast, as illustrated in FIG. 4, when the position of the spines 204 of the books 200 on the upper side and the position of the spines 204 of the books 200 on the lower side are opposite to each other about the center CL of the books 200, the height H1 on one side (the left side in FIG. 4) of the book block BK matches the height H2 on the other side (the right side in FIG. 4) of the book block BK.

In such a state, even when the number of stacked books 200 increases, no difference occurs between the height H1 on one side and the height H2 on the other side of the book block BK. Therefore, the books 200 on the upper side is not misaligned from the books 200 on the lower side, or the whole book block BK does not collapse. The three-side cutting apparatus 100 of the present embodiment transports the plurality of books 200 to a stacking position so that the height H1 on one side of the book block BK matches the height H2 on the other side of the book block BK, as illustrated in FIG. 4.

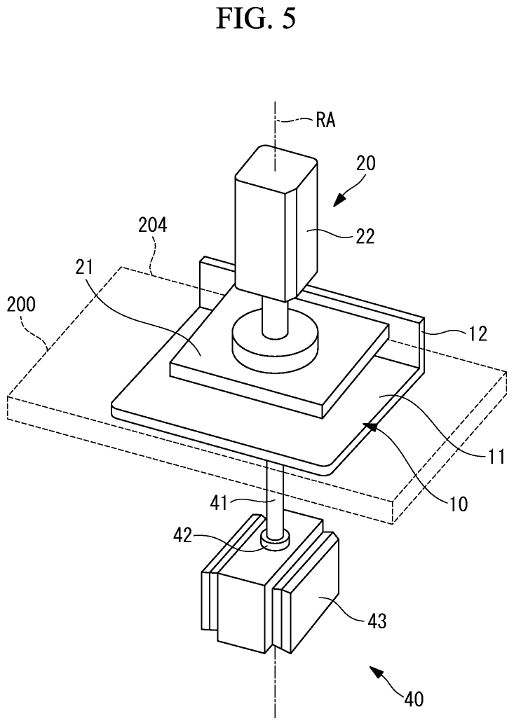

The mechanism to rotate the book 200 when cutting the book 200 by the cutting unit 30 will now be described. The three-side cutting apparatus 100 rotates the rotary table 10 by the drive unit 40 while pressing the book 200 against the rotary table 10 by the pressing unit 20. FIG. 5 is a partial enlarged view of a part near the rotary table of the three-side cutting apparatus illustrated in FIG. 1.

The rotary table 10 is a member on which a single book 200 having a bound spine 204 may be placed. As illustrated in FIG. 5, the rotary table 10 has a table body 11 on which the book 200 may be placed and an abutment part 12 erecting in the perpendicular direction continuously from the edge of the table body 11. The spine 204 of the book 200 is abutted against the abutment part 12 by a positioning mechanism (not illustrated).

The pressing unit 20 is a mechanism that presses the book 200 against the table body 11 of the rotary table 10 and thereby fixes the book 200 to the rotary table 10 so that the book 200 is not rotated relative to the rotary table 10. As illustrated in FIG. 5, the pressing unit 20 has a pressing plate 21 arranged above the table body 11 and a pressing plate lift 22 connected to the upper face of the pressing plate 21. The pressing plate lift 22 is formed of an air cylinder, for example.

The pressing unit 20 lowers the pressing plate 21 by the pressing plate lift 22 and thereby presses the upper face of the book 200, which is placed on the table body 11, by the under face of the pressing plate 21 to fix the book 200 onto the table body 11.

The drive unit 40 is a mechanism that rotates the rotary table 10 with the book 200 being pressed by the pressing unit 20. As illustrated in FIG. 5, the drive unit 40 has a rotary shaft 41 extending in the perpendicular direction and connected to the under face of the table body 11, a bearing 42 that supports the rotary shaft 41, and a motor 43 that rotates the rotary shaft 41 about a rotation axis RA.

As illustrated in FIG. 1, the drive unit 40 has a motion mechanism 44 that moves the rotary table 10 and the pressing unit 20 in directions in which the rotary table 10 and the pressing unit 20 come close to or are spaced away from the cutting unit 30. The motion mechanism 44 moves the rotary table 10 relative to the cutting unit 30 and thereby switches the state between a cutting state of being capable to cut the book 200 and a non-cutting state of being not capable to cut the book 200.

The cutting unit 30 has a cutting knife 31, a receiving part 32, and a drive mechanism (not illustrated) that moves the cutting knife 31 to come close to or be spaced away from the receiving part 32. The cutting unit 30 moves the cutting knife 31 from the non-cutting position (the position illustrated in FIG. 1) to the cutting position (the position where the cutting knife 31 comes into contact with the receiving part 32) by the drive mechanism when the book 200 is in the cutting state set by the motion mechanism 44. The book 200 is cut when the cutting knife 31 comes into contact with the book 200 and then moves to the receiving part 32. The cutting unit 30 cuts each of three sides of the fore edge 201, the top edge 202, and the bottom edge 203 of the book 200 that are edges except for the spine 204.

The transport unit 50 has a chuck head 51 configured to grip a cut book 200, as illustrated in FIG. 1. The transport unit 50 uses a drive mechanism (not illustrated) to transport the chuck head 51 gripping the book 200 in the transport direction TD from the cutting unit 30 to a stacking position where a shelf 61 of the accumulation unit 60 is arranged.

The accumulation unit 60 has the shelf 61 on which the cut book 200 may be placed, a lift mechanism 62 that lifts and lowers the shelf 61, and a conveyer 63 that supplies the book 200 placed on the shelf 61 to an input port 71 of the discharge unit 70.

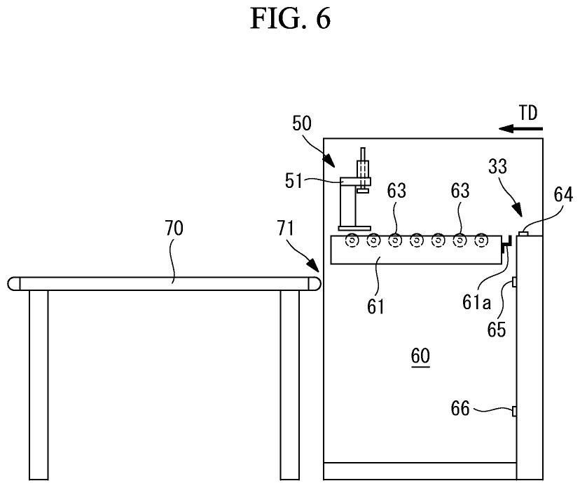

The discharge unit 70 is formed of a belt conveyer, a drive roller conveyer, or a free roller conveyer and is a device that discharges the book 200 supplied from the accumulation unit 60 to the input port 71. Herein, the operation of stacking the book 200, which is transported from the cutting unit 30 by the transport unit 50, on the stacking position of the accumulation unit 60 and discharging the book 200 from the accumulation unit 60 to the discharge unit 70 will be described with reference to FIG. 6 to FIG. 8.

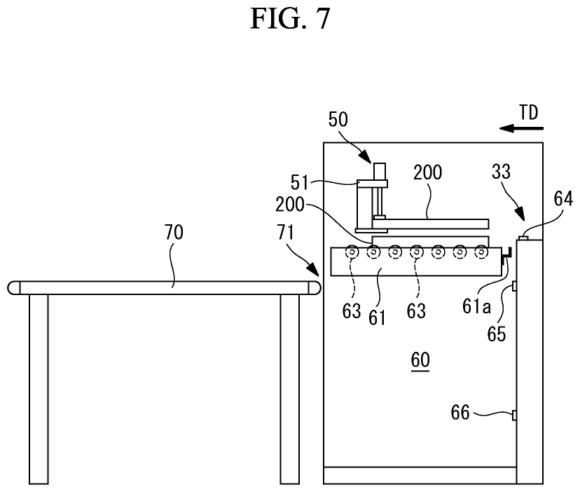

FIG. 6 is a front view illustrating the transport unit 50, the accumulation unit 60, and the discharge unit 70 and illustrates a state where the book 200 is not stacked on the shelf 61. The shelf 61 is arranged at the same level as the output port 33 of the cutting unit 30. The accumulation unit 60 transports the book 200 in the transport direction TD by the transport unit 50 from the state illustrated in FIG. 6 and then lowers the shelf 61 by a distance corresponding to the thickness of the book 200, and this results in the state illustrated in FIG. 7.

FIG. 7 is a front view illustrating the transport unit 50, the accumulation unit 60, and the discharge unit 70 and illustrates a state where the book 200 is stacked on the shelf 61. The accumulation unit 60 lowers the shelf 61 on which the book 200 is placed to a position where emission light emitted horizontally from a photoelectric sensor 64 is not blocked. The accumulation unit 60 repeats the operation of lowering the shelf 61 by the distance corresponding to the thickness of the book 200 every time a new book 200 is stacked on the shelf 61.

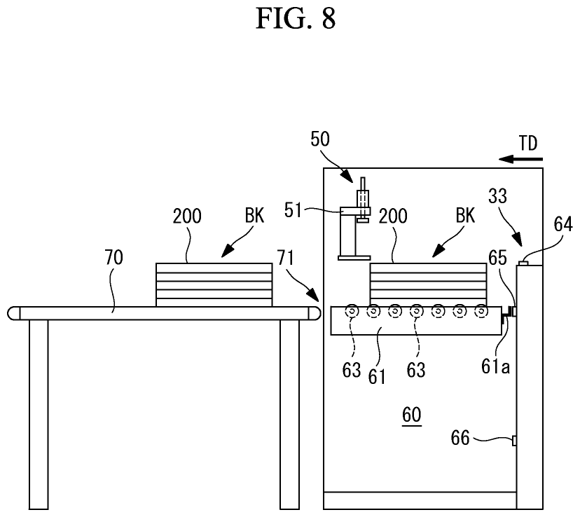

As illustrated in FIG. 6 to FIG. 8, a plate to be detected 61a is attached to the shelf 61. A proximity sensor 65 provided to the accumulation unit 60 detects the plate to be detected 61a when a plurality of books 200 whose height corresponds to the level difference between the output port 33 of the cutting unit 30 and the input port 71 of the discharge unit 70 are stacked on the shelf 61. FIG. 8 is a front view illustrating the transport unit 50, the accumulation unit 60, and the discharge unit 70 and illustrates a state where the proximity sensor 65 detects the plate to be detected 61a. In response to the state illustrated in FIG. 8 being established, the accumulation unit 60 operates the conveyer 63 to transport the book block BK including the plurality of books 200 stacked on the shelf 61 to the discharge unit 70.

Although the accumulation unit 60 transports the book block BK stacked on the accumulation unit 60 to the discharge unit 70 in response to the proximity sensor 65 detecting the plate to be detected 61a in the above description, another form may be employed. For example, the book block BK stacked on the accumulation unit 60 may be accumulated on the accumulation unit 60 without being transported to the discharge unit 70. In such a case, when the proximity sensor 66 detects the plate to be detected 61a, the control unit 90 determines that the accumulation unit 60 are full of the books 200 stacked thereon and stops the lowering of the shelf 61.

The supply unit 80 has a supply table 81, a feeder unit 82, and a transport unit 83, as illustrated in FIG. 1. The feeder unit 82 feeds a plurality of books 200 placed on the supply table 81 to the transport unit 83 one by one. The transport unit 83 transports the book 200 supplied from the feeder unit 82 to the cutting unit 30 one by one in the transport direction TD.

The control unit 90 is a device that controls each unit of the three-side cutting apparatus 100 including the pressing unit 20, the cutting unit 30, the drive unit 40, the transport unit 50, and the supply unit 80. The control unit 90 controls each unit of the three-side cutting apparatus 100 by loading a program stored in a storage unit (not illustrated) and executing the program.

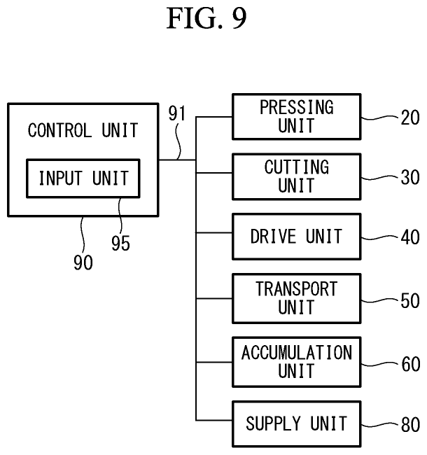

Next, the process performed by the control unit 90 of the three-side cutting apparatus 100 will be described with reference to FIG. 9 to FIG. 20. FIG. 9 is a block diagram illustrating a general configuration of the three-side cutting apparatus 100. As illustrated in FIG. 9, the control unit 90 can transfer control signals to the pressing unit 20, the cutting unit 30, the drive unit 40, the transport unit 50, the accumulation unit 60, and the supply unit 80 and receive signals from respective units via signal lines 91.

The control unit 90 has an input unit 95 having a touch panel display (not illustrated), for example. The operator of the three-side cutting apparatus 100 sets various settings for controlling the three-side cutting apparatus 100 to the control unit 90 via the input unit 95.

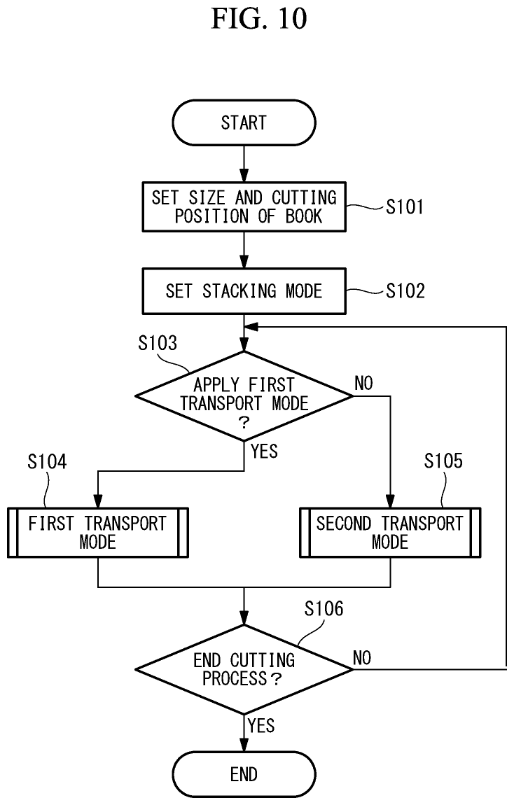

FIG. 10 is a flowchart illustrating a control method of the three-side cutting apparatus 100 performed by the control unit 90 of the present embodiment. As illustrated in FIG. 10, in step S101, the control unit 90 sets a size and cutting positions of the book 200 to be cut by the cutting unit 30 in accordance with an operator's input operation to the input unit 95. The cutting positions are positions corresponding to the cut line L1 on the fore edge 201 side, the cut line L2 on the top edge 202 side, and the cut line L3 on the bottom edge 203 side illustrated in FIG. 2.

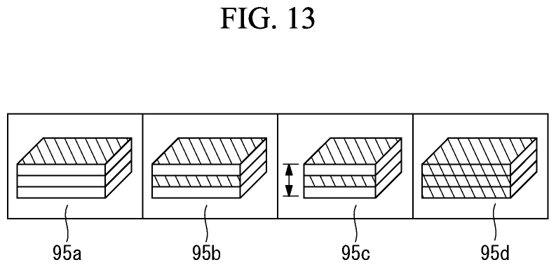

In step S102, the control unit 90 sets a stacking mode in the cutting process performed by the three-side cutting apparatus 100. FIG. 13 is a diagram illustrating a setting window for setting a stacking mode. The operator sets any one of a plurality of stacking modes via the setting window displayed on the input unit 95. As illustrated in FIG. 13, any one of a normal stacking mode 95a, an alternating delivery stacking mode with rotation by the number of books 95b, an alternating delivery stacking mode with rotation by height 95c, and a reverse stacking mode 95d can be set as a stacking mode.

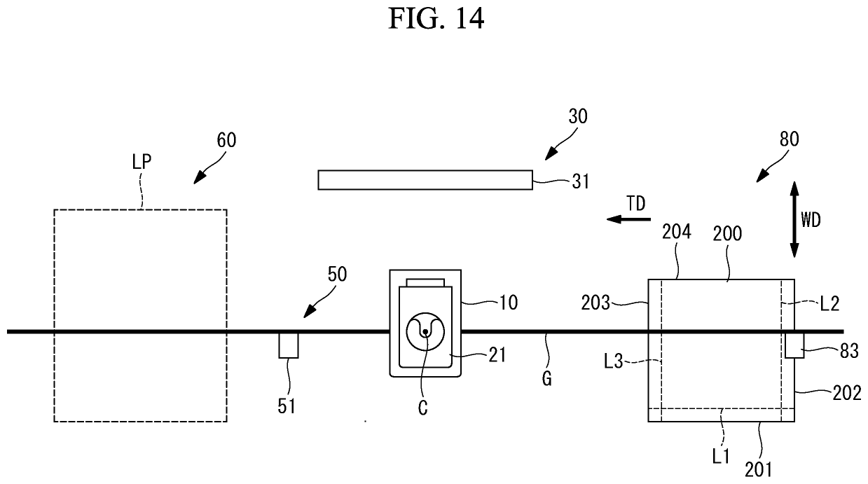

The normal stacking mode 95a and the reverse stacking mode 95d each are a stacking mode to have the same position of the spines 204 of the plurality of books 200 stacked on the stacking position LP (see FIG. 14). The position of the spines 204 of the plurality of books 200 stacked on the stacking position LP in the normal stacking mode 95a differs by 180 degrees about the center of the books 200 from that in the reverse stacking mode 95d.

The alternating delivery stacking mode with rotation by the number of books 95b and the alternating delivery stacking mode with rotation by height 95c each are a mode to differentiate the position of the spines 204 of some of the plurality of books 200 by 180 degrees from the position of the spines 204 of the remaining of the plurality of books 200 stacked on the stacking position LP.

An alternating delivery stacking mode with rotation by the number of books 95b is a mode to switch the position of the spine 204 of the book 200 stacked on the stacking position LP in response to books of a predetermined number specified by the operator via the input unit 95 being stacked on the stacking position LP. The alternating delivery stacking mode with rotation by height 95c is a mode to switch the position of the spine 204 of the book 200 stacked on the stacking position LP so that the height (the total thickness) of the plurality of books 200 stacked on the stacking position LP with the same position of the spines 204 does not exceed a predetermined height specified by the operator via the input unit 95.

In step S103, the control unit 90 determines whether or not to perform a first transport mode and, if YES, performs the first transport mode in step S104 (first control step) or, if NO, performs a second transport mode in step S105 (second control step). The control unit 90 makes the determination of step S103 every time each single book 200 is cut by the cutting unit 30 and performs either the first transport mode or the second transport mode.

The first transport mode is a mode to transport the book 200, which has the edges cut by the cutting unit 30, in the transport direction TD in a state where the spine 204 has been rotated to be arranged in a predetermined direction about the rotation center C of the rotary table 10. The second transport mode is a mode to transport the book 200, which has the edges cut by the cutting unit 30, in the transport direction TD in a state where the spine 204 has been rotated to be arranged in a direction opposite to the predetermined direction about the rotation center C of the rotary table 10.

If the normal stacking mode 95a is set in step S102, the control unit 90 determines, in step S103, to perform the first transport mode to all the plurality of books 200. If the reverse stacking mode 95d is set in step S102, the control unit 90 determines, in step S103, to perform the second transport mode to all the plurality of books 200.

If the alternating delivery stacking mode with rotation by the number of books 95b is set in step S102, the control unit 90 determines, in step S103, to perform the first transport mode until books of a predetermined number specified by the operator via the input unit 95 are stacked on the stacking position LP. The control unit 90 determines to perform the second transport mode in response to books of the predetermined number specified by the operator via the input unit 95 being stacked on the stacking position LP.

Further, the control unit 90 determines to perform the second transport mode until the predetermined number of books are stacked on the stacking position LP after the switching to the second transport mode. The control unit 90 determines to perform the first transport mode in response to the predetermined number of books being stacked on the stacking position LP after the switching to the second transport mode. As described above, the control unit 90 switches determination to perform the first transport mode and determination to perform the second transport mode therebetween every time a predetermined number of books 200 are stacked on the stacking position LP.

If the alternating delivery stacking mode with rotation by height 95c is set in step S102 and if it is determined in step S103 that the height of the plurality of books 200 stacked on the stacking position LP with the same position of the spines 204 does not exceed a predetermined height specified by the operator via the input unit 95, the control unit 90 determines to perform the first transport mode. If it is determined that the height of the plurality of books 200 exceeds the predetermined height specified by the operator via the input unit 95, the control unit 90 determines to perform the second transport mode so that the book 200 in question is not transported to the stacking position LP and thus not stacked above the predetermined height.

Further, after the switching to the second transport mode, if it is determined that the height of the plurality of books 200 stacked on the stacking position LP with the same position of the spines 204 does not exceed the predetermined height specified by the operator via the input unit 95, the control unit 90 determines to perform the second transport mode. If it is determined that the height of the plurality of books 200 exceeds the predetermined height specified by the operator via the input unit 95, the control unit 90 determines to perform the first transport mode so that the book 200 in question is not transported to the stacking position LP and thus not stacked above the predetermined height. As described above, the control unit 90 switches determination to perform the first transport mode and determination to perform the second transport mode therebetween every time the upper limit number of books 200 that do not exceed the predetermined height are stacked on the stacking position LP.

In step S106, the control unit 90 determines whether or not to end the cutting process and, if YES, ends the process of the flowchart of FIG. 10 or, if NO, again performs step S103. If the book 200 to be continuously processed is present, the control unit 90 determines NO and performs the first transport mode or the second transport mode to a plurality of books 200.

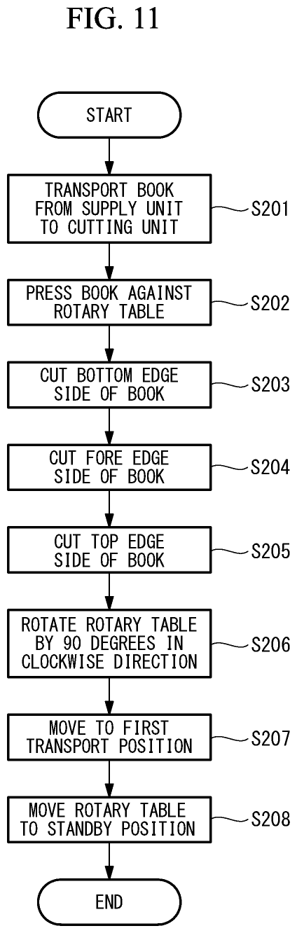

Next, the first transport mode will be described with reference to FIG. 11. FIG. 11 is a flowchart illustrating each process in the first transport mode performed in FIG. 10.

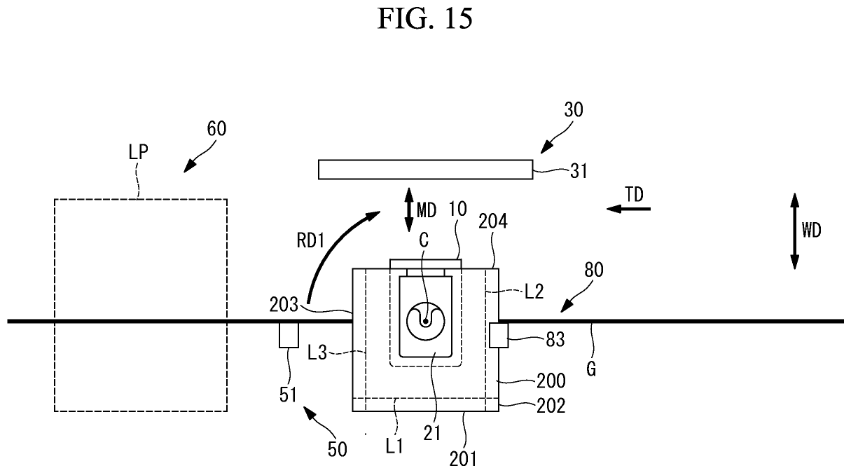

In step S201, the control unit 90 controls the supply unit 80 so as to transport the book 200 from the supply unit 80 to the cutting unit 30. FIG. 14 illustrates a state where the transport unit 83 of the supply unit 80 holds the book 200. The transport unit 83 moves in the transport direction TD on a guide G while holding the book 200 and places the book 200 on the rotary table 10. FIG. 15 illustrates a state where the book 200 is placed on the rotary table 10.

In step S202, the control unit 90 controls the pressing unit 20 so as to press the book 200 against the rotary table 10.

In step S203, the control unit 90 controls the cutting unit 30 and the drive unit 40 so as to cut the bottom edge 203 side of the book 200. In the state illustrated in FIG. 15, the control unit 90 controls the drive unit 40 so as to rotate the rotary table 10 by 90 degrees in the clockwise rotation direction RD1 about the rotation center C.

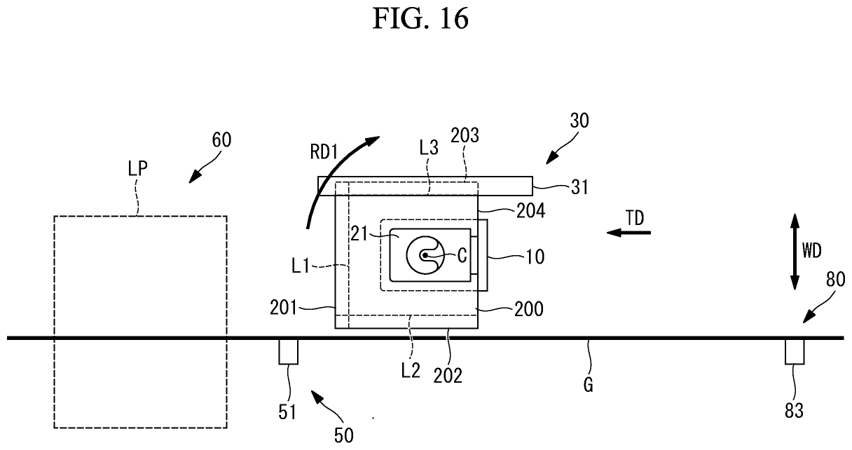

Further, the control unit 90 moves the rotary table 10 to the cutting unit 30 in a moving direction MD orthogonal to the transport direction TD so that the cut line L3 on the bottom edge 203 side matches the cutting position of the cutting knife 31, and this results in the state illustrated in FIG. 16. The control unit 90 moves the cutting knife 31 from the non-cutting position to the cutting position and cuts the bottom edge 203 of the book 200 along the cut line L3.

In step S204, the control unit 90 controls the cutting unit 30 and the drive unit 40 so as to cut the fore edge 201 side of the book 200. In the state illustrated in FIG. 16, the control unit 90 controls the drive unit 40 so as to rotate the rotary table 10 by 90 degrees in the clockwise rotation direction RD1 about the rotation center C.

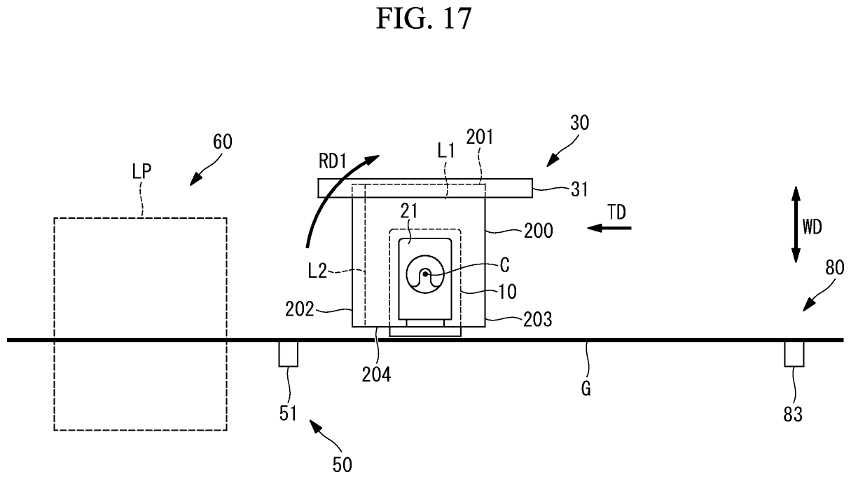

Further, the control unit 90 moves the rotary table 10 in the moving direction MD orthogonal to the transport direction TD so that the cut line L1 on the fore edge 201 side matches the cutting position of the cutting knife 31, and this results in the state illustrated in FIG. 17. The control unit 90 moves the cutting knife 31 from the non-cutting position to the cutting position and cuts the fore edge 201 of the book 200 along the cut line L1.

In step S205, the control unit 90 controls the cutting unit 30 and the drive unit 40 so as to cut the top edge 202 side of the book 200. In the state illustrated in FIG. 17, the control unit 90 controls the drive unit 40 so as to rotate the rotary table 10 by 90 degrees in the clockwise rotation direction RD1 about the rotation center C.

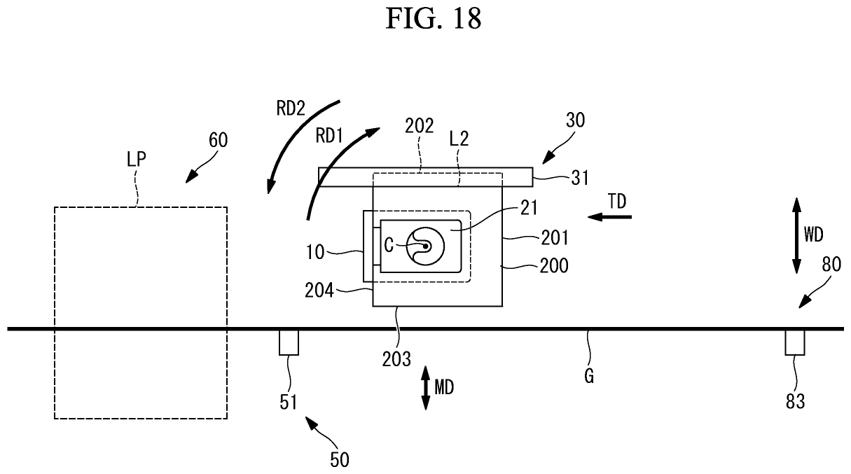

Further, the control unit 90 moves the rotary table 10 in the moving direction MD orthogonal to the transport direction TD so that the cut line L2 on the top edge 202 side matches the cutting position of the cutting knife 31, and this results in the state illustrated in FIG. 18. The control unit 90 moves the cutting knife 31 from the non-cutting position to the cutting position and cuts the top edge 202 of the book 200 along the cut line L2.

In step S206, the control unit 90 controls the drive unit 40 so as to rotate the rotary table 10 by 90 degrees in the clockwise rotation direction RD1 in the state illustrated in FIG. 18.

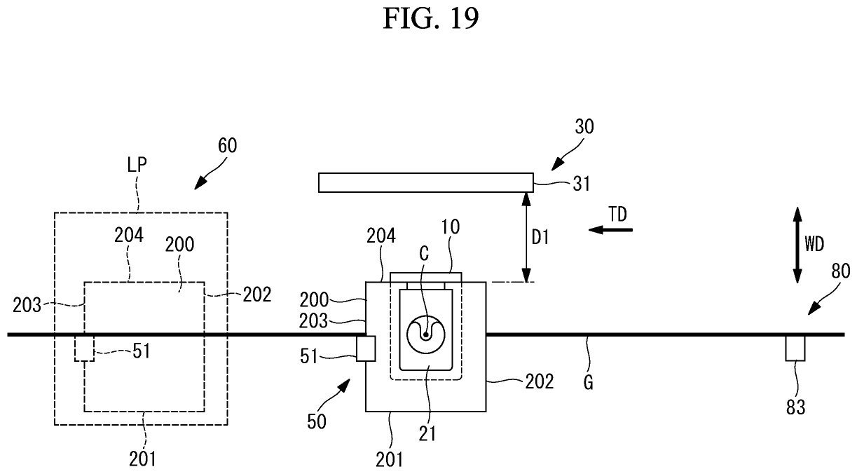

In step S207, the control unit 90 moves the rotary table 10 to a first transport position in the direction away from the cutting unit 30 in the moving direction MD, and this results in the state illustrated in FIG. 19.

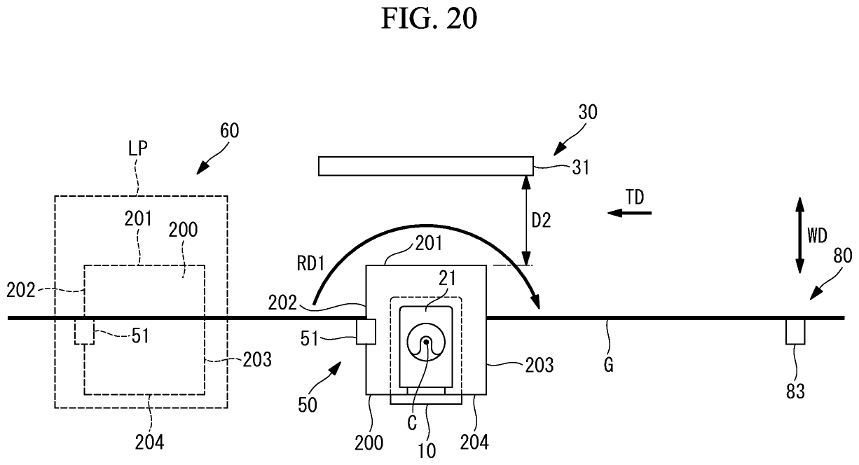

The first transport position is a position where the distance from the cutting knife 31 to the spine 204 of the book 200 is a distance D1 in accordance with the size of the book 200 in the width direction WD orthogonal to the transport direction TD. The distance D1 is the same distance as the distance D2 illustrated in FIG. 20, and the position of the spine 204 of the book 200 placed on the rotary table 10 moved to the first transport position matches the position of the fore edge 201 of the book 200 placed on the rotary table 10 moved to a second transport position described later.

In step S208, the control unit 90 controls the pressing unit 20 so as to release the state where the pressing unit 20 presses the book 200 against the rotary table 10. The control unit 90 controls the transport unit 50 so that the chuck head 51 grips the bottom edge 203 of the cut book 200 and transports the book 200 from the cutting unit 30 to the stacking position LP of the accumulation unit 60. The book 200 transported by the transport unit 50 is stacked on the position indicated by a dotted line in FIG. 19.

In step S208, the control unit 90 moves the rotary table 10 in the moving direction MD to cause the rotation center C of the rotary table 10 to match the rotation center C in a standby position illustrated in FIG. 14. This is the end of the first transport mode to a single book 200.

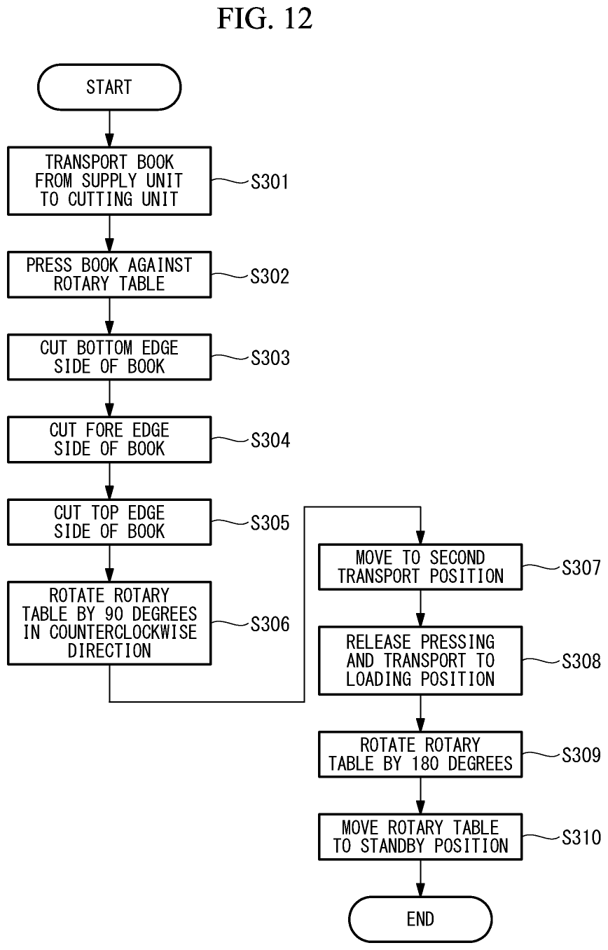

Next, the second transport mode will be described with reference to FIG. 12. FIG. 12 is a flowchart illustrating each process in the second transport mode performed in FIG. 10. Since the process from step S301 to step S305 illustrated in FIG. 12 is the same as the process from step S201 to step S205 illustrated in FIG. 11, the description thereof will be omitted below.

In step S306, the control unit 90 controls the drive unit 40 so as to rotate the rotary table 10 by 90 degrees in the counterclockwise rotation direction RD2 in the state illustrated in FIG. 18.

In step S307, the control unit 90 moves the rotary table 10 to the second transport position in the direction away from the cutting unit 30 in the moving direction MD, and this results in the state illustrated in FIG. 20.

The second transport position is a position where the distance from the cutting knife 31 to the fore edge 201 of the book 200 is a distance D2 in accordance with the size of the book 200 in the width direction WD orthogonal to the transport direction TD. The distance D2 is the same distance as the distance D1 illustrated in FIG. 19, and the position of the fore edge 201 of the book 200 placed on the rotary table 10 moved to the second transport position matches the position of the spine 204 of the book 200 placed on the rotary table 10 moved to the first transport position.

In step S308, the control unit 90 controls the pressing unit 20 so as to release the state where the pressing unit 20 presses the book 200 against the rotary table 10. The control unit 90 controls the transport unit 50 so that the chuck head 51 grips the top edge 202 of the cut book 200 and transports the book 200 from the cutting unit 30 to the stacking position LP of the accumulation unit 60. The book 200 transported by the transport unit 50 is stacked on the position indicated by a dotted line in FIG. 20.

In step S309, the control unit 90 controls the drive unit 40 so as to rotate the rotary table 10 by 180 degrees in the clockwise rotation direction RD1 in the state illustrated in FIG. 20.

Further, in step S310, the control unit 90 moves the rotary table 10 in the moving direction MD to cause the rotation center C of the rotary table 10 to match the rotation center C in a standby position illustrated in FIG. 14. This is the end of the second transport mode to a single book 200.

As illustrated in FIG. 19, in the book 200 transported by the transport unit 50 in the first transport mode, the direction in which the spine 204 extends matches the transport direction TD. Further, as illustrated in FIG. 20, in the book 200 transported by the transport unit 50 in the second transport mode, the direction in which the spine 204 extends matches the transport direction TD. The control unit 90 controls the drive unit 40 so that the direction in which the spine 204 extends matches the transport direction TD in both the first transport mode and the second transport mode.

As illustrated in FIG. 19, the control unit 90 controls the drive unit 40 in the first transport mode so that the distance from the cutting knife 31 to the spine 204 of the book 200 is the distance D1 in accordance with the size of the book 200 in the width direction WD orthogonal to the transport direction TD. Further, as illustrated in FIG. 20, the control unit 90 controls the drive unit 40 in the second transport mode so that the distance from the cutting knife 31 to the fore edge 201 of the book 200 is the distance D2 in accordance with the size of the book 200 in the width direction WD.

Further, when stacking a plurality of books 200 on the stacking position LP while switching the first transport mode and the second transport mode therebetween for the book 200 having a predetermined size, the control unit 90 controls the drive unit 40 so that the distance D1 matches the distance D2. That is, the control unit 90 controls the drive unit 40 so that, in the width direction WD, the position of the spine 204 of the book 200 transported in the first transport mode matches the position of the fore edge 201 of the book 200 transported in the second transport mode.

With such an operation, in the book block BK stacked on the stacking position LP, the position of the fore edge 201 of the book 200 transported in the first transport mode matches the position of the spine 204 of the book 200 transported in the second transport mode. Further, in the book block BK stacked on the stacking position LP, the position of the spine 204 of the book 200 transported in the first transport mode matches the position of the fore edge 201 of the book transported in the second transport mode. Further, if the number of books transported in the first transport mode and the number of books transported in the second transport mode are the same, the books of the book block BK are stably stacked so that the heights at respective positions are substantially the same as illustrated in FIG. 4.

The effects and advantages achieved by the three-side cutting apparatus 100 of the present embodiment described above will be described.

According to the three-side cutting apparatus 100 of the present embodiment, the book 200 having the bound spine 204 is pressed against the rotary table 10 by the pressing unit 20, and the rotary table 10 is rotated and positioned to the cutting unit 30 by the drive unit 40. The book 200 having the edges cut by the cutting unit 30 is transported in the transport direction TD to the stacking position LP by the transport unit 50. The drive unit 40 and the transport unit 50 are controlled by the control unit 90 so as to perform the first transport mode and the second transport mode in a switchable manner.

The first transport mode and the second transport mode are switched therebetween and performed, and thereby the spine 204 of the book 200 transported to the stacking position LP in the first transport mode and the spine 204 of the book 200 transported to the stacking position LP in the second transport mode are arranged in opposite directions (directions rotated by 180 degrees from each other) about the rotation center C of the rotary table 10.

Therefore, compared to a case where all the spines 204 of a plurality of books 200 stacked on the stacking position LP are arranged in the same direction about the rotation center C of the rotary table 10, it is possible to prevent some of the books 200 stacked on the upper side from being misaligned from books 200 stacked on the lower side or prevent the plurality of books 200 from collapsing due to a situation where the height of one area of the books is excessively higher than the height of another area of the books.

As described above, according to the three-side cutting apparatus 100 of the present embodiment, it is possible to suitably stack a plurality of books 200 each having a bound spine 204 while preventing the books 200 from collapsing without requiring the operator to work to change the orientation of some of the books 200 or an additional device to be provided for changing the orientation of some of the books 200.

According to the three-side cutting apparatus 100 of the present embodiment, since the position of the spine 204 of the book 200 transported in the first transport mode matches the position of a fore edge 201 of the book 200 transported in the second transport mode, a plurality of books 200 stacked on the stacking position LP are suitably stacked on the same position in the width direction WD.

According to the three-side cutting apparatus 100 of the present embodiment, when the alternating delivery stacking mode with rotation by the number of books 95b is set as the stacking mode, the first transport mode and the second transport mode are switched therebetween in response to completion of transport of a predetermined number of books. Thus, the position of the spine 204 and the position of the fore edge 201 of the books 200 stacked on the stacking position LP are switched therebetween for every predetermined number of books 200, and misalignment or collapse of a plurality of books 200 can be suitably prevented.

According to the three-side cutting apparatus 100 of the present embodiment, when the alternating delivery stacking mode with rotation by height 95c is set as the stacking mode, the transport mode is switched so that the height (the total thickness) of the books 200 continuously transported in either the first transport mode or the second transport mode does not exceed a predetermined value. Thus, the position of the spine 204 and the position of the fore edge 201 of the books 200 stacked on the stacking position LP are switched therebetween in accordance with the height (the total thickness) of the plurality of stacked books 200, and misalignment or collapse of a plurality of books 200 can be suitably prevented.

Although the cutting unit 30 is fixed and the position of the rotary table 10 is moved relative to the cutting unit 30 by the drive unit 40 in the above description, another form may be employed. For example, the position of the rotary table 10 may be fixed, the cutting unit 30 may be provided with a drive mechanism, and the position of the cutting unit 30 may be moved relative to the rotary table 10.

Although, in the above description, the second transport mode is the mode to transport the book 200 having the edges cut by the cutting unit 30 in the transport direction TD in a state where the spine 204 has been rotated to be arranged in an opposite direction to (the direction rotated by 180 degrees from) the predetermined direction about the rotation center C of the rotary table 10, another form may be employed. For example, the second transport mode may be a mode to transport the book 200 having the edges cut by the cutting unit 30 in the transport direction TD in a state where the spine 204 has been rotated to be arranged in a different direction to (any direction including the direction rotated by 180 degrees but not including the same direction as) the predetermined direction about the rotation center C of the rotary table 10.

Although the book 200 is transported from the supply unit 80 to the cutting unit 30 one by one, cut by the cutting unit 30, and transported to the accumulation unit 60 by the transport unit 50 in both the first transport mode and the second transport mode in the above description, another form may be employed. For example, the books 200 may be transported from the supply unit 80 to the cutting unit 30 by each predetermined number of books that is two or greater, cut by the cutting unit 30, and transported to the accumulation unit 60 by the transport unit 50.

Specifically, the transport unit 83 may transport the books 200 supplied from the feeder unit 82 to the cutting unit 30 in the transport direction TD by each predetermined number of books that is two or greater. In such a case, the cutting unit 30 collectively cuts the books 200 of a predetermined number that is two or greater. Further, the transport unit 50 collectively transports, to the accumulation unit 60, the books 200 of a predetermined number that is two or greater that have been cut by the cutting unit 30. Further, the determination of switching between the first transport mode and the second transport mode made by the control unit 90 (the determination in step S103) is performed on every predetermined number of books that is two or greater.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A cutting apparatus comprising:
a rotary table on which a book having a bound spine is to be placed;
a pressing unit configured to press the book against the rotary table;
a cutting unit configured to move a cutting knife between a cutting position and a non-cutting position and cut edges of the book except for the spine;
a drive unit configured to rotate the rotary table with the book being pressed by the pressing unit and move the rotary table to the cutting unit;
a transport unit configured to transport the book having the edges cut by the cutting unit in a transport direction to a stacking position; and
a control unit configured to control the drive unit and the transport unit,
wherein the control unit is configured to perform a first transport mode and a second transport mode in a switchable manner, the first transport mode is to transport the book having the edges cut by the cutting unit in the transport direction in a state where the spine was rotated to be arranged in a predetermined direction about a rotation center of the rotary table, and the second transport mode is to transport the book having the edges cut by the cutting unit in the transport direction in a state where the spine was rotated to be arranged in a direction different from the predetermined direction about the rotation center.

2. The cutting apparatus according to claim 1, wherein the second transport mode is a mode to transport the book having the edges cut by the cutting unit in the transport direction in a state where the spine was rotated to be arranged in an opposite direction to the predetermined direction about the rotation center.

3. The cutting apparatus according to claim 2, wherein the control unit controls the drive unit so that a direction in which the spine extends matches the transport direction in both the first transport mode and the second transport mode.

4. The cutting apparatus according to claim 3, wherein the control unit controls the drive unit so that, in a width direction orthogonal to the transport direction, the position of the spine of the book transported in the first transport mode matches the position of a fore edge of the book transported in the second transport mode.

5. The cutting apparatus according to claim 1, wherein the control unit switches the first transport mode to the second transport mode in response to completion of transport of a predetermined number of books in the first transport mode and switches the second transport mode to the first transport mode in response to completion of transport of the predetermined number of books in the second transport mode.

6. The cutting apparatus according to claim 1, wherein the control unit switches the first transport mode to the second transport mode so that a total thickness of books continuously transported in the first transport mode does not exceed a predetermined value and switches the second transport mode to the first transport mode so that a total thickness of books continuously transported in the second transport mode does not exceed the predetermined value.

7. A control method of a cutting apparatus, wherein the cutting apparatus comprises
a rotary table on which a book having a bound spine is to be placed,
a pressing unit configured to press the book against the rotary table,
a cutting unit configured to move a cutting knife between a cutting position and a non-cutting position and cut edges of the book except for the spine,
a drive unit configured to rotate the rotary table with the book being pressed by the pressing unit and move the rotary table to the cutting unit, and
a transport unit configured to transport the book having the edges cut by the cutting unit in a transport direction to a stacking position, the control method comprising:
a first control step of performing a first transport mode to control the drive unit and the transport unit to transport the book having the edges cut by the cutting unit in the transport direction in a state where the spine was rotated to be arranged in a predetermined direction about a rotation center of the rotary table; and
a second control step of performing a second transport mode to control the drive unit and the transport unit to transport the book having the edges cut by the cutting unit in the transport direction in a state where the spine was rotated to be arranged in a direction different from the predetermined direction about the rotation center.

8. The control method of the cutting apparatus according to claim 7, wherein the second transport mode is to transport the book having the edges cut by the cutting unit in the transport direction in a state where the spine was rotated to be arranged in an opposite direction to the predetermined direction about the rotation center.

9. The control method of the cutting apparatus according to claim 8, wherein the first control step and the second control step control the drive unit so that a direction in which the spine extends matches the transport direction.

10. The control method of the cutting apparatus according to claim 9, wherein the first control step and the second control step control the drive unit so that, in a width direction orthogonal to the transport direction, the position of the spine of the book transported in the first transport mode matches the position of a fore edge of the book transported in the second transport mode.

11. The control method of the cutting apparatus according to claim 7, wherein the first transport mode is switched to the second transport mode in response to completion of transport of a predetermined number of books in the first transport mode, and the second transport mode is switched to the first transport mode in response to completion of transport of the predetermined number of books in the second transport mode.

12. The control method of the cutting apparatus according to claim 7, wherein the first transport mode is switched to the second transport mode so that a total thickness of books continuously transported in the first transport mode does not exceed a predetermined value, and the second transport mode is switched to the first transport mode so that a total thickness of books continuously transported in the second transport mode does not exceed the predetermined value.
